(19) United States
(12) Patent Application Publication
(10) Pub. No.: US 2015/0194125 A1
(43) Pub. Date: Jul. 9, 2015

(54) METHOD AND SYSTEM FOR ADJUSTING OUTPUT OF DISPLAY

(71) Applicant: Samsung Electronics Co., Ltd., Gyeonggi-do (KR)

(72) Inventors: Woosung CHOI, Gyeonggi-do (KR); Hyoungil KIM, Gyeonggi-do (KR); Jungeun LEE, Gyeonggi-do (KR)

(21) Appl. No.: 14/590,535

(22) Filed: Jan. 6, 2015

(30) Foreign Application Priority Data
Jan. 6, 2014 (KR) 10-2014-0001549

(51) Int. Cl. G09G 5/00

(52) U.S. Cl. CPC G09G 5/003; G09G 2320/0613

(57) ABSTRACT

Methods and apparatuses are provided for adjusting output of a display. Data related to the display output is acquired. It is determined whether to adjust a screen refresh rate of the display based on the acquired data. The screen refresh rate is adjusted or maintained according to a result of the determination.

### PRIORITY

The present application claims priority under 35 U.S.C. §119(a) to Korean Patent Application No. 10-2014-0001549, filed on Jan. 6, 2014, the content of which is incorporated herein by reference.

### BACKGROUND OF THE INVENTION

1. Field of the Invention

The present disclosure relates generally to electronic devices, and more particularly, to a method for adjusting an output of a display and an electronic device therefor.

2. Description of the Related Art

A variety of electronic devices have been developed and are widely used in various fields. Most electronic devices are equipped with displays and systems for controlling their functions via the displays.

Video data is used to show images on the screen of an electronic device at a screen refresh rate that is adjusted according to a preset value. For example, if an electronic device provides a complicated screen for game contents, such as, for example, a shooting game, the screen refresh rate is increased. On the contrary, if the electronic device provides a simple screen for game contents, such as, for example, a puzzle game, it does not need to provide a higher screen refresh rate than the shooting game.

In order to output contents (e.g., game contents) that vary greatly in form on a screen, the display needs to operate at a high screen refresh rate (e.g., 120 Hz). However, as the screen refresh rate of a display increases, there is an increased chance of overloading the Graphics Processing Unit (GPU). The high screen refresh rate also increases battery power consumption and heat generation in the electronic device, which may result in improper operation. In addition, it is difficult to immediately adjust a screen refresh rate to comply with video data since the amount of video data is so large that the processor may be too overloaded to analyze it.

### SUMMARY OF THE INVENTION

The present invention has been made to address at least the above problems and/or disadvantages and to provide at least the advantages described below. Accordingly, an aspect of the present invention provides a system and method for dynamically adjusting a screen refresh rate of a display according to a user's movements, thereby optimizing performance and enhancing the convenience.

In accordance with an embodiment of the present invention, a method is provided for adjusting output of a display. Data related to the display output is acquired. It is determined whether to adjust a screen refresh rate of the display based on the acquired data. The screen refresh rate is adjusted or maintained according to a result of the determination.

In accordance with another embodiment of the present invention, a method is provided for adjusting an output of a display. Data related to the display output is acquired. The acquired data is compared with previous data. A screen refresh rate of the display is adjusted or maintained according to a result of the comparison.

In accordance with another embodiment of the present disclosure, an electronic device is provided that includes a sensor configured to acquire data related to a display output. The electronic device also includes a controller configured to determine whether to adjust a screen refresh rate of the display based on the acquired data, and adjust or maintain the screen refresh rate according to a result of the determination.

In accordance with another embodiment of the present disclosure, a non-transitory computer-readable recording medium is provided, which includes a program for executing operations of: acquiring data related to a display output; determining whether to adjust a screen refresh rate of the display based on the acquired data; and adjusting or maintaining the screen refresh rate based on a result of the determination.

### BRIEF DESCRIPTION OF THE DRAWINGS

The above and other aspects, features, and advantages of the present invention will be more apparent from the following detailed description when taken in conjunction with the accompanying drawings, in which:

FIG. 1 is a block diagram illustrating a network environment including an electronic device, according to an embodiment of the present invention;

FIG. 2 is a block diagram illustrating an electronic device, according to an embodiment of the present invention;

FIG. 3 is a flow chart illustrating a method for adjusting output of a display, according to an embodiment of the present invention;

FIGS. 4A and 4B are diagrams illustrating a method for adjusting a screen refresh rate, according to an embodiment of the present invention;

FIG. 5 is a flow chart illustrating a method for adjusting output of a display, according to another embodiment of the present invention;

FIG. 6 is a block diagram illustrating an electronic device, according to an embodiment of the present invention;

FIG. 7 is a diagram illustrating a support for holding an electronic device, according to an embodiment of the present invention; and

FIGS. 8A and 8B are diagrams illustrating a head-mounted device, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

As used herein, the expression “include” or “may include” refers to the existence of a corresponding function, operation, or constituent element, and does not exclude the use of one or more additional functions, operations, or constituent elements. Further, as used herein, the term such as “include” or “have” may be construed to denote a certain characteristic, number, step, operation, constituent element, component or a combination thereof, and does not exclude the existence of or a possibility of one or more other characteristics, numbers, steps, operations, constituent elements, components or combinations thereof.

As used herein, the expression “or” includes any or all combinations of words enumerated together. For example, the expression “A or B” may include A, B, or both A and B.

While expressions including ordinal numbers, such as “first” and “second”, as used herein may modify various constituent elements, such constituent elements are not limited by the above expressions. For example, the above expressions do not limit the sequence and/or importance of the corresponding constituent elements. The above expressions may be used merely for the purpose of distinguishing a constituent element from other constituent elements. For example, a first user device and a second user device indicate different user devices although both are user devices. A first constituent element may be referred to as a second constituent element, and likewise a second constituent element may also be referred to as a first constituent element without departing from the scope of the present invention.

When a component is referred to as being “connected to” or “accessed by” any other component, the component may be directly connected to or accessed by the other component, or another component may be interposed there between. Contrarily, when a component is referred to as being “directly connected to” or “directly accessed by” any other component, there is no other component there between.

The terms used herein are used merely for the purpose of describing particular embodiments and are not intended to limit the embodiments of the present invention. Singular forms are intended to include plural forms unless the context clearly indicates otherwise.

Unless defined otherwise, all terms used herein, including technical terms and scientific terms, have the same meanings as those commonly understood by a person of ordinary skill in the art to which the present invention pertains. Terms that are defined in a generally used dictionary are to be interpreted to have the meanings equal to the contextual meanings in the relevant field of art, and are not to be interpreted to have ideal or excessively formal meanings unless clearly defined herein.

An electronic device, according to the present invention, may be a device including a communication function. For example, the electronic device may be embodied as at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), an MP3 player, a mobile medical appliance, a camera, and a wearable device (e.g., a head-mounted-device (HMD) such as electronic glasses, electronic clothes, an electronic bracelet, an electronic necklace, an electronic accessory, electronic tattoos, or a smart watch).

According to some embodiments of the present invention, the electronic device may be a smart home appliance with a communication function. The smart home appliance may be embodied as at least one of a television, a digital video disk (DVD) player, an audio player, a refrigerator, an air conditioner, a vacuum cleaner, an oven, a microwave oven, a washing machine, an air cleaner, a set-top box, a TV box, a game console, an electronic dictionary, an electronic key, a camcorder, and an electronic photo frame.

According to some embodiments of the present invention, the electronic devices may be embodied as at least one of various medical devices (e.g., magnetic resonance angiography (MRA), magnetic resonance imaging (MRI), computed tomography (CT), and ultrasonic machines), navigation equipment, a global positioning system (GPS) receiver, an event data recorder (EDR), a flight data recorder (FDR), an automotive infotainment device, electronic equipment for ships (e.g., ship navigation equipment and a gyrocompass), avionics, security equipment, a vehicle head unit, an industrial or home robot, an automatic teller machine (ATM) of a banking system, and a point of sales (POS) in a shop.

According to some embodiments of the present invention, the electronic device may be embodied as at least one of a part of furniture or a building/structure, an electronic board, an electronic signature receiving device, a projector, and various kinds of measuring instruments (e.g., a water meter, an electric meter, a gas meter, and a radio wave meter). The electronic device, according to an embodiment of the present invention, may be a combination of one or more of the aforementioned various devices. Further, the electronic device, according to an embodiment of the present invention, may be a flexible device. Further, it will be apparent to those skilled in the art that the electronic device is not limited to the aforementioned devices.

Hereinafter, an electronic device, according to various embodiments of the present invention, will be described with reference to the accompanying drawings. The term “a user” as used herein may refer to any person who uses an electronic device or any other device (e.g., an artificial intelligence electronic device) using an electronic device.

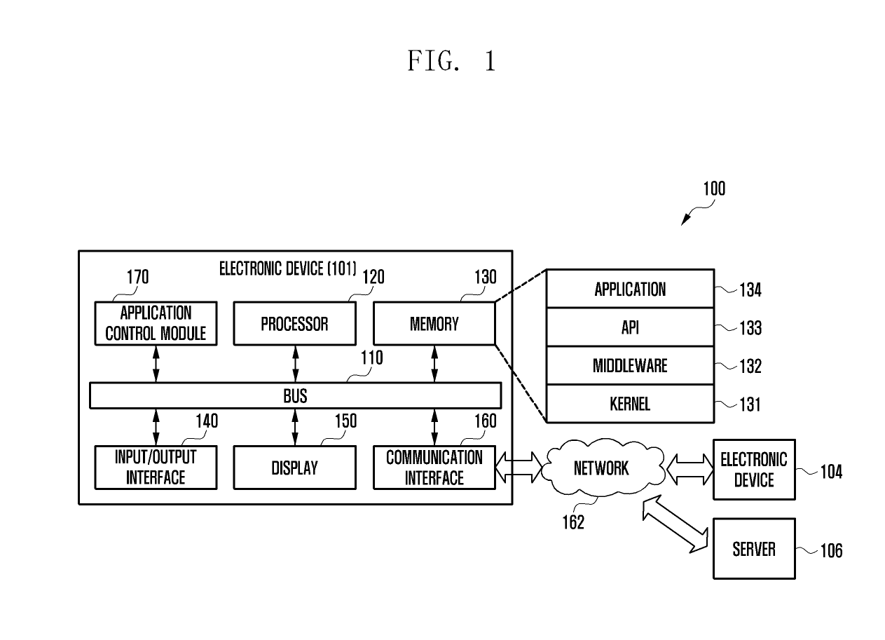

FIG. 1 is a diagram illustrating a network environment 100 including an electronic device 101, according to an embodiment of the present invention. Referring to FIG. 1, the electronic device 101 includes a bus 110, a processor 120, a memory 130, an input/output interface 140, a display 150, a communication interface 160, and an application control module 170.

The bus 110 is a circuit interconnecting the aforementioned components and transmitting communication (e.g., a control message) between the aforementioned components.

The processor 120, for example, receives instructions from the aforementioned components (e.g., the memory 130, the input/output interface 140, the display 150, the communication interface 160, and the application control module 170) through the bus 110, decodes the received instructions, and performs operations or data processing according to the decoded instructions.

The memory 130 stores instructions or data received from or generated by the processor 120 or other components (e.g., the input/output interface 140, the display 150, the communication interface 160, and the application control module 170). The memory 130 includes programming modules, such as, for example, a kernel 131, middleware 132, an application programming interface (API) 133, and applications 134. Each of the programming modules as described above may be formed by software, firmware, hardware, or a combination of two or more thereof.

The kernel 131 controls or manages system resources (e.g., the bus 110, the processor 120, and the memory 130) used to execute operations or functions implemented in the remaining other programming modules, for example, the middleware 132, the API 133, and the applications 134. Further, the kernel 131 provides an interface that allows the middleware 132, the API 133, or the applications 134 to access and control or manage individual components of the electronic device 101.

The middleware 132 serves to mediate between the API 133 or the applications 134 and the kernel 131. Specifically, the middleware 132 allows the API 133 or the application 134 to communicate and exchange data with the kernel 131. Further, the middleware 132 performs control (e.g., scheduling or load balancing) for task requests received from the applications 134 by using, for example, a method of assigning a priority for use of the system resource (e.g., the bus 110, the processor 120, or the memory 130) of the electronic device 101 to at least one of the applications 134.

The API 133 is an interface for allowing the applications 134 to control functions provided by the kernel 131 and the middleware 132, and includes at least one interface or function (e.g., instruction) for, for example, file control, window control, image processing, or text control.

According to an embodiment of the present invention, the applications 134 includes an SMS/MMS application, an e-mail application, a calendar application, an alarm application, a health care application (e.g., an application for measuring the amount of exercise or blood glucose), and an environmental information application (e.g., an application for providing atmospheric pressure information, humidity information, temperature information, and the like). Additionally or alternatively, the applications 134 may include an application associated with information exchange between the electronic device 101 and an external electronic device (e.g., the electronic device 104). The application associated with information exchange, for example, may include a notification relay application for transferring specific information to the external electronic device or a device management application for managing the external electronic device.

The input/output interface 140, for example, transfers instructions or data, input from a user through an input/output device (e.g., a sensor, a keyboard, or a touch screen), to the processor 120, the memory 130, the communication interface 160, or the application control module 170 through the bus 110.

The display 150 displays various pieces of information (e.g., multimedia data or text data) to a user.

The communication interface 160 establishes communication between the electronic device 101 and an external electronic device (e.g., the electronic device 104 or the server 106). For example, the communication interface 160 may be connected to the network 162 through wireless or wired communication and thereby communicate with the external device. According to an embodiment of the present invention, the network 162 may be a telecommunications network. The telecommunications network may include at least one of a computer network, the Internet, and a telephone network. According to an embodiment of the present invention, a protocol (e.g., a transport layer protocol, a data link layer protocol, or a physical layer protocol) for communication between the electronic device 101 and an external device may be supported by at least one of the applications 134, the application programming interface 133, the middleware 132, the kernel 131, and the communication interface 160.

The application control module 170 processes at least some pieces of information acquired from other components (e.g., the processor 120, the memory 130, the input/output interface 140, and the communication interface 160) and provide the processed information to a user in various ways. For example, the application control module 170 may recognize information on connection components provided in the electronic device 101, store the information on connection components in the memory 130, and execute the applications 130, based on the stored information on connection components.

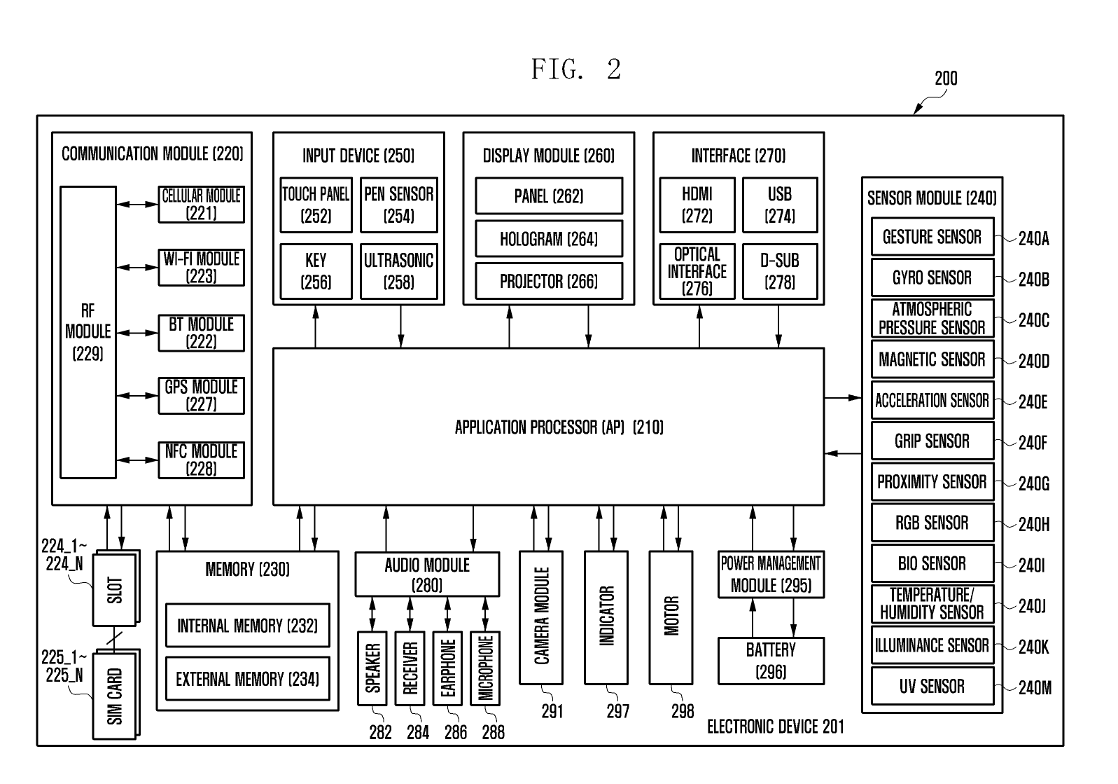

FIG. 2 is a block diagram illustrating an electronic device, according to an embodiment of the present invention. The electronic device 200, for example, may constitute all or a part of the electronic device 101 shown in FIG. 1. Referring to FIG. 2, the electronic device 200 includes at least one application processor (AP) 210, a communication module 220, one or more subscriber identity module (SIM) card slots 224_1˜224_N, a memory 230, a sensor module 240, an input device 250, a display module 260, an interface 270, an audio module 280, a camera module 291, a power management module 295, a battery 296, an indicator 297, and a motor 298.

The AP 210 drives an operating system or an application program to control a plurality of hardware or software components connected to the AP 210, and performs processing and operations of various data including multimedia data. The AP 210, for example, may be implemented as a system on chip (SoC). According to an embodiment of the present invention, the AP 210 may further include a graphic processing unit (GPU).

The communication module 220 (e.g., the communication interface 160) performs data transmission/reception in communication with other electronic devices (e.g., the electronic device 104 and the server 106) connected to the electronic device 200 (e.g., the electronic device 101) through a network. According to an embodiment of the present invention, the communication module 220 includes a cellular module 221, a WiFi module 223, a BT module 222 a GPS module 227, an NFC module 228, and a radio frequency (RF) module 229.

The cellular module 221 provides a voice call, a video call, an SMS service, an Internet service, and the like through a communication network (e.g., LTE, LTE-A, CDMA, WCDMA, UMTS, WiBro, or GSM). Also, the cellular module 221 identifies and authenticates an electronic device in a communication network by using, for example, a subscriber identification module (e.g., the SIM card). According to an embodiment of the present invention, the cellular module 221 performs at least some of the functions that may be provided by the AP 210. For example, the cellular module 221 may perform at least a multimedia control function.

According to an embodiment of the present invention, the cellular module 221 includes a communication processor (CP). Further, the cellular module 221, for example, may be implemented as a SoC. Although the cellular module 221 (e.g., a CP), the memory 230, the power management module 295, and the like are shown as separate elements from the AP 210 in FIG. 2, the AP 210 may be implemented to include at least some (e.g., the cellular module 221) of the aforementioned elements.

According to an embodiment of the present invention, the AP 210 or the cellular module 221 (e.g., a CP) loads a command or data received from at least one of a non-volatile memory and other elements connected thereto into a volatile memory and process the loaded command or data. Further, the AP 210 or the cellular module 221 stores data received from or generated by at least one of other elements in a non-volatile memory.

Each of the WiFi module 223, the BT module 222, the GPS module 227, and the NFC module 228, for example, includes a processor for processing data transmitted or received through the corresponding module. Although the cellular module 221, the WiFi module 223, the BT module 222, the GPS module 227, and the NFC module 228 are shown as separate blocks in FIG. 2, at least some (e.g., two or more) of the cellular module 221, the WiFi module 223, the BT module 222, the GPS module 227, and the NFC module 228 may be included in one integrated chip (IC) or one IC package, according to an embodiment of the present invention.

The RF module 229 performs data transmission/reception, for example, RF signal transmission/reception. The RF module 229, for example, may include a transceiver, a power amp module (PAM), a frequency filter, a low noise amplifier (LNA), and the like. Also, the RF module 229 may further include a component for transmitting/receiving an electromagnetic wave over the air in wireless communication, such as a conductor or a conducting wire. Although FIG. 2 shows that the cellular module 221, the WiFi module 223, the BT module 222, the GPS module 227, and the NFC module 228 share one RF module 229, at least one of the cellular module 221, the WiFi module 223, the BT module 222, the GPS module 227, and the NFC module 228 may perform RF signal transmission/reception through a separate RF module, according to an embodiment of the present invention.

At least one SIM card 225_1 to 225_N is a card including a subscriber identification module, and may be inserted into the at least one slot 224_1 to 224_N formed in a certain position of the electronic device. The at least one SIM card 225_1 to 225_N may include unique identification information (e.g., integrated circuit card identifier (ICCID)) or subscriber information (e.g., international mobile subscriber identity (IMSI)).

The memory 230 (e.g., the memory 130) includes an internal memory 232 or an external memory 234. The internal memory 232, for example, may include at least one of a volatile memory (e.g., a dynamic RAM (DRAM), a static RAM (SRAM), or a synchronous dynamic RAM (SDRAM)) and a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a NAND flash memory, or an NOR flash memory).

According to an embodiment of the present invention, the internal memory 232 may be a solid state drive (SSD). The external memory 234 may further include a flash drive, for example, a compact flash (CF), a secure digital (SD), a micro secure digital (Micro-SD), a mini secure digital (Mini-SD), an extreme digital (xD), or a memory stick. The external memory 234 may be functionally connected to the electronic device 200 through various interfaces. According to an embodiment of the present invention, the electronic device 200 may further include a storage device (or storage medium), such as a hard drive.

The sensor module 240 measures a physical quantity or detects an operation state of the electronic device 200 and converts the measured or detected information into an electronic signal. The sensor module 240, for example, includes at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, a light sensor 240K, and an ultraviolet (UV) sensor 240M. Additionally or alternatively, the sensor module 240, for example, may include an E-nose sensor, an electromyography (EMG) sensor, an electroencephalogram (EEG) sensor, an electrocardiogram (ECG) sensor, an infrared (IR) sensor, an iris scanner, and/or a fingerprint sensor. The sensor module 240 may further include a control circuit for controlling one or more sensors included therein.

The input module 250 includes a touch panel 252, a (digital) pen sensor 254, a key 256, or an ultrasonic input unit 258. The touch panel 252 that recognizes a touch input, for example, may include at least one of a capacitive touch panel, a resistive touch panel, an infrared touch panel, and an acoustic wave touch panel. Also, the touch panel 252 may further include a control circuit. When the touch panel is a capacitive touch panel, it may recognize a physical contact or proximity. The touch panel 252 may also further include a tactile layer. In this case, the touch panel 252 may provide a tactile response to a user.

The (digital) pen sensor 254, for example, is implemented using a means identical or similar to that for receiving a touch input from a user or using a separate recognition sheet. The key 256, for example, includes a physical button, an optical key, or a keypad. The ultrasonic input unit 258 identifies data by generating an ultrasonic signal through an input tool and detecting a sonic wave through a microphone (e.g., microphone 288) in the electronic device 600, and is capable of wireless recognition.

The display 260 (e.g., the display 150) includes a panel 262, a hologram unit 264, or a projector 266. The panel 262, for example, may be a liquid crystal display (LCD) or an active matrix-organic light emitting diode (AM-OLED). The panel 262, for example, may be implemented to be flexible, transparent, or wearable. The panel 262 may also be incorporated into one module together with the touch panel 252. The hologram unit 264 shows a stereoscopic image in the air by using light interference. The projector 266 displays an image by projecting light onto a screen. The screen, for example, may be located inside or outside of the electronic device 200. According to an embodiment of the present invention, the display 260 may further include a control circuit for controlling the panel 262, the hologram unit 264, or the projector 266.

The interface 270, for example, includes a high-definition multimedia interface (HDMI) 272, a universal serial bus (USB) 274, an optical interface 276, or a D-subminiature (D-sub) 278. The interface 270, for example, is included in the communication interface 160 shown in FIG. 1. Additionally or alternatively, the interface 290, for example, includes a mobile high-definition link (MHL) interface, a secure digital (SD) card/multimedia card (MMC) interface, or an infrared data association (IrDA) interface.

The audio module 280 provides bidirectional conversion between a sound and an electronic signal. At least some elements of the audio module 280, for example, may be included in the input/output interface 140 shown in FIG. 1. The audio module 280, for example, may process sound information input or output through a speaker 282, a receiver 284, earphones 286, or the microphone 288.

The camera module 291 is a device that can take both still and moving images, and according to an embodiment of the present invention, includes one or more image sensors (e.g., a front sensor or a rear sensor), a lens, an image signal processor (ISP), or a flash (e.g., an LED or xenon lamp).

The power management module 295 manages power of the electronic device 200. The power management module 295, for example, includes a power management integrated circuit (PMIC), a charger IC, or a battery or fuel gauge.

The PMIC, for example, may be mounted in an IC or an SoC semiconductor. Charging methods may be classified into wired charging and wireless charging. The charger IC may charge a battery, and may prevent an overvoltage or excess current from being induced or flowing from a charger.

The battery gauge, for example, measures the residual capacity, charge in voltage, current, or temperature of the battery 296. The battery 296 stores or generates electricity, and supplies power to the electronic device 200 by using the stored or generated electricity.

The indicator 297 displays a specific status of the electronic device 200 or a part thereof (e.g., the AP 210), for example, a boot-up status, a message status, or a charging status. The motor 298 converts an electrical signal into a mechanical vibration. Although not shown, the electronic device 200 may include a processing unit (e.g., GPU) for supporting a mobile TV. The processing unit for supporting a mobile TV may process media data pursuant to a certain standard, for example, digital multimedia broadcasting (DMB), digital video broadcasting (DVB), or media flow.

Each of the above described elements of the electronic device, according to embodiments of the present invention, may be formed by one or more components, and the names of the corresponding elements may vary according to the type of the electronic device. The electronic device, according to an embodiment of the present invention, may include at least one of the above described elements, and may exclude some of the elements or further include other additional elements. Further, some of the elements of the electronic device, according to an embodiment of the present invention, may be coupled to form a single entity while performing the same functions as those of the corresponding elements before the coupling.

The term “module” as used herein, for example, refers to a unit including one or more of hardware, software, and firmware. The “module”, for example, may be interchangeable with the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module”, according to an embodiment the present invention may include at least one of an application-specific integrated circuit (ASIC) chip, a field-programmable gate array (FPGA), and a programmable-logic device for performing certain operations.

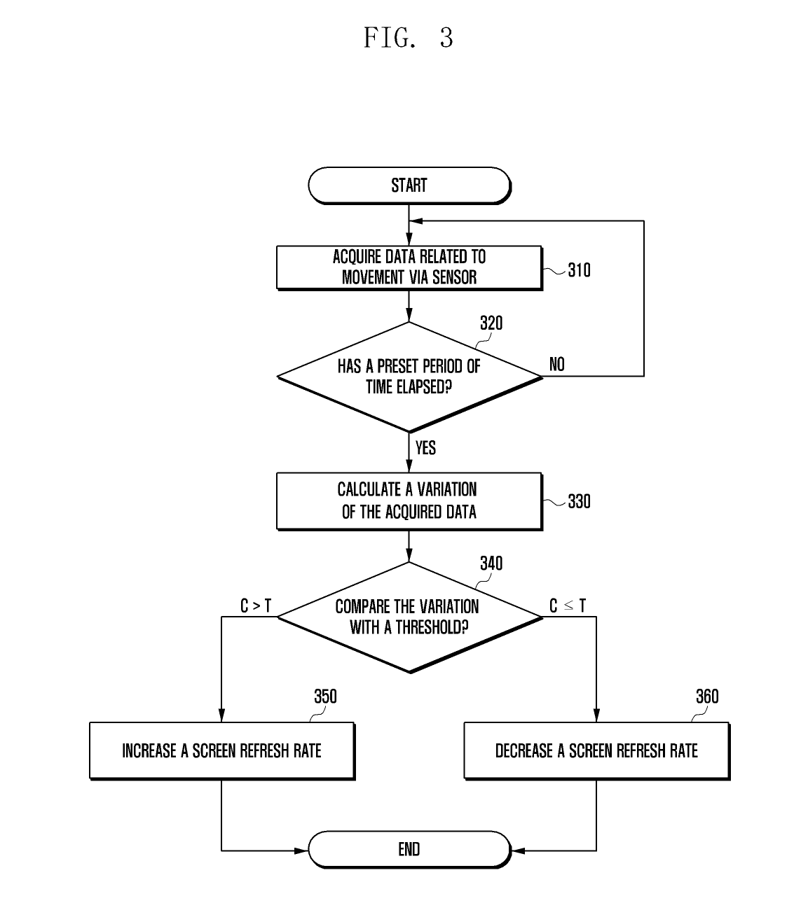

FIG. 3 is a diagram illustrating a flow chart that describes a method for adjusting output of a display, according to an embodiment of the present invention. The method may be adapted to, for example, the electronic device 101 shown in FIG. 1.

Referring to FIG. 3, the electronic device acquires data related to output of a display via the sensor, in step 310. The data related to output of a display via the sensor is data related to movements, and is referred to as ‘sensor data’ or ‘data.’ In an embodiment of the present invention, the sensor may be one of the following: a gyro sensor, an acceleration sensor, a humidity sensor, a proximity sensor, an infrared sensor, an illuminance sensor, an image sensor, an earth magnetic field sensor, etc.

The controller of the electronic device determines whether a preset period of time has elapsed, in step 320. Specifically, the electronic device operates a timer from a time point when the data is acquired. The timer can be set to count down a preset period of time. The sensor can acquire data for the preset period of time, i.e., while the timer is operating. In an embodiment of the present invention, the preset period of time may be set to any time interval, e.g., 3, 5, 10 seconds, etc.

The controller calculates a variation in the data acquired by the sensor, in step 330. For example, the controller can calculate the variation in the data acquired by the sensor for the preset period of time.

The controller determines whether the variation (C) exceeds a threshold (T), i.e., C>T, in step 340. The controller may adjust a screen refresh rate of a display based on whether the variation exceeds the threshold. The screen refresh rate may be a frame rate or a refresh rate.

The frame rate is expressed in frames per second. When video signals are transmitted to displays, such as, for example, monitors, televisions, etc., the frame rate sets the number of consecutive images (frames) to be transmitted per second, considering human eye characteristics.

The refresh rate refers to the number of times per second that electron beams are shot onto a monitor to retain a screen thereon. For example, a cathode ray tube (CRT) monitor shows and retains an image on the screen as the three electron guns shoot electron beams at the phosphors on the surface of the CRT monitor and thereby light them up with the image. Since the emission time of phosphors is very short, electron guns repeatedly shoot electron beams at the phosphors to show and retain an image on the screen. Therefore, a refresh rate of 60 Hz means that electron guns shoot electron beams 60 times in a second. The higher the refresh rate, the less the screen flickers. In embodiments of the present invention, the refresh rate may also be used for V-Sync displays. Although a CRT monitor is described above, the monitor is described herein includes general displays, such as, for example, LCD, OLED, etc. Therefore, when the embodiments of the present invention employ general displays, the refresh rate serves to retain screens on the displays.

Referring again to FIG. 3, when the controller determines that the variation (C) exceeds the threshold (T), i.e., C>T, in operation 340, it increases the screen refresh rate to be greater than a threshold refresh rate, in step 350. The threshold refresh rate may be set according to one of the following: the type of electronic device, the performance of the electronic device, and video data displayed on the display. For example, the threshold refresh rate may be set to 60 Hz. Therefore, when the variation (C) exceeds the threshold (T), i.e., C>T, the controller increases the screen refresh rate to 120 Hz, which is greater than 60 Hz. In order to prevent battery power consumption, the controller may lower the resolution of the display.

On the contrary, when the controller ascertains that the variation (C) is less than or equal to the threshold (T), i.e., C<T, it decreases the screen refresh rate to be less than the threshold refresh rate, in step 360. Alternatively, when the variation (C) is less than or equal to the threshold (T), i.e., C<T, the controller may retain the screen refresh rate at the threshold refresh rate.

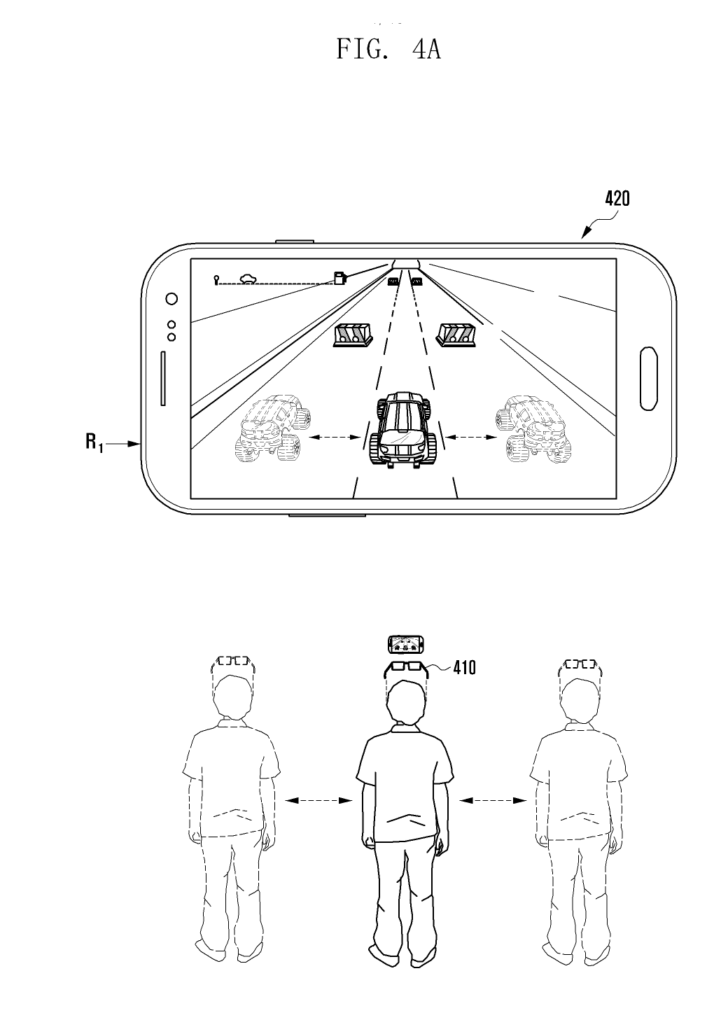

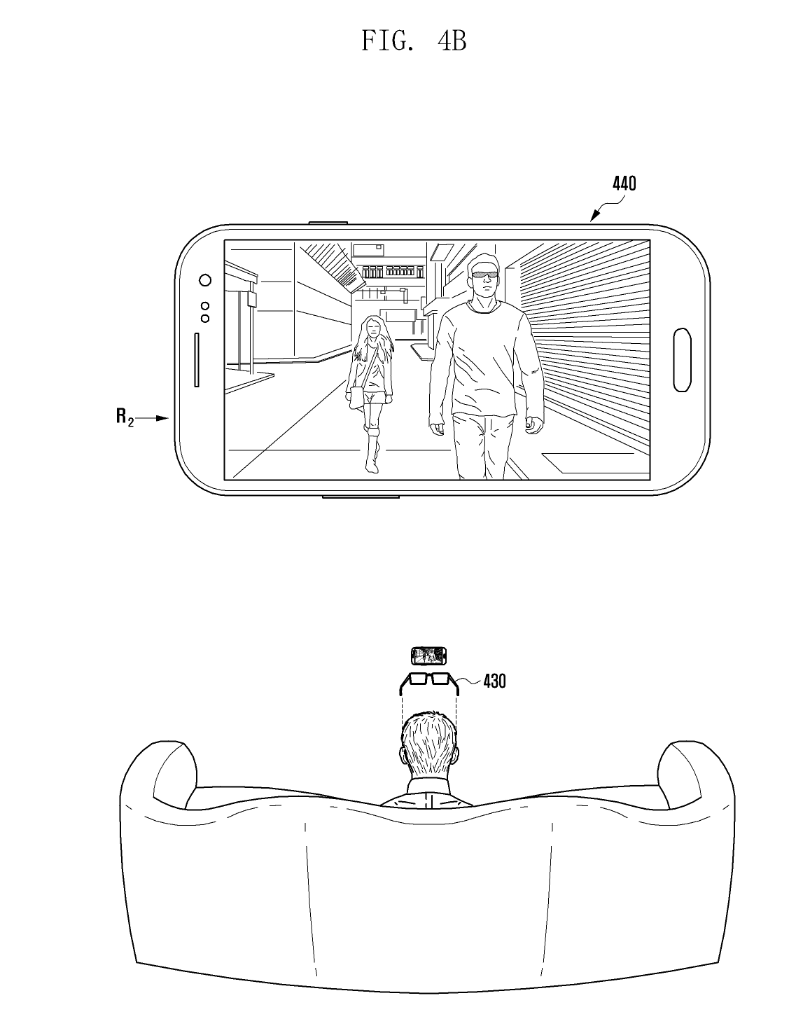

FIGS. 4A and 4B are diagrams illustrating a method for adjusting a screen refresh rate, according to an embodiment of the present invention.

Referring to FIG. 4A, an electronic device 410 is embodied as a head-mounted device (HMD) including a lens unit. The HMD may include a support. A display can be installed to or separated from the support. The display installed to the support may display images on the screen. The images are transferred to the user's eyes through the lens unit.

In an embodiment of the present invention, a user of the electronic device 410 is playing a ‘car racing game’ and viewing an enlarged screen 420, as shown in FIG. 4A. The electronic device 410 can execute the ‘car racing game’ according to a user's movement. Since the electronic device 410 must display video data, in real-time, according to the velocity and direction of the car, the screen refresh rate needs to be high. Therefore, when the electronic device 410 determines that the variation in the data related to a user's movement exceeds a threshold, it adjusts the screen refresh rate (R₁) to be greater than the threshold refresh rate.

On the contrary, a user sitting on a sofa and can view a movie on an enlarged screen 440 of an electronic device 430, as shown in FIG. 4B. The electronic device 430 acquires data related to a user's movement. When the electronic device 430 determines that the variation in the acquired data is less than or equal to the threshold, it retains the screen refresh rate (R₂) at the threshold refresh rate. That is, if the electronic device 430 doesn't detect a user's movement as the user is sitting on a sofa viewing a movie, it retains the screen refresh rate at the threshold refresh rate or adjusts the screen refresh rate to be less than the threshold refresh rate.

Therefore, according to embodiments of the present invention, the electronic device dynamically adjusts the screen refresh rate for the display based on the user's movements, thereby providing optimal performance and enhancing convenience.

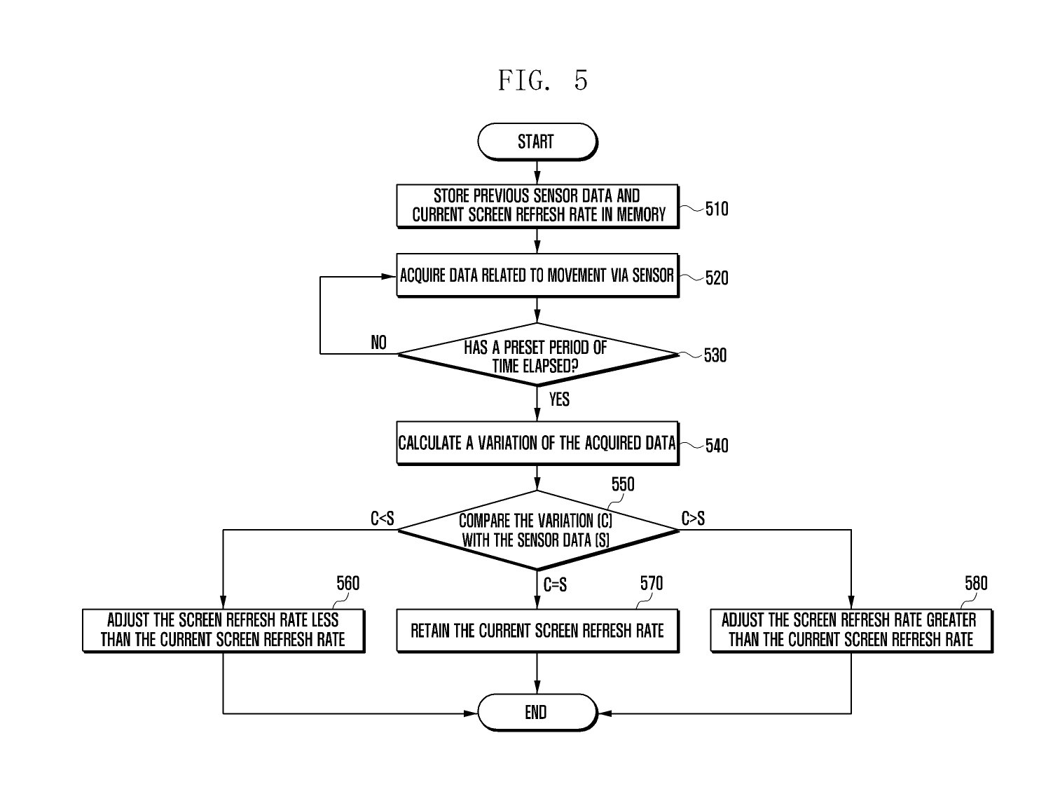

FIG. 5 is a diagram illustrating a flow chart that describes a method for adjusting output of a display, according to another embodiment of the present invention.

Referring to FIG. 5, the electronic device stores previous data and a current screen refresh rate in a memory, in step 510.

The electronic device acquires data related to a screen display via a sensor, in step 520. The data related to the screen display may include data related to a user's movements and may be acquired by at least one of the following: a gyro sensor, acceleration sensor, humidity sensor, proximity sensor, infrared sensor, illuminance sensor, image sensor, and earth magnetic field sensor.

The previous data, stored in the memory in step 510, is data acquired before the sensor is operated or data related to a current screen refresh rate at a time point that the sensor acquires data in step 520. The current screen refresh rate corresponds to the previous data.

In an embodiment of the present invention, steps 510 and 520 are performed simultaneously.

The controller of the electronic device determines whether a preset period of time has elapsed, in step 530. Specifically, the electronic device operates a timer from a time point when it acquires the data. The sensor can acquire data for the preset period of time, i.e., while the timer is operating. The preset period of time may be set by the electronic device.

The controller calculates a variation in the data acquired by the sensor, in step 540. For example, the controller can calculate the variation in the data acquired by the sensor for a preset period of time.

The controller compares the variation (C) with that of the previous data (S), in step 550. The controller adjusts a screen refresh rate of a display based on the comparison result. The screen refresh rate may be the frame rate or the refresh rate.

When the controller determines that the variation (C) is less than that of the previous data (S), i.e., C<S, in step 550, it adjusts the screen refresh rate to be less than the current screen refresh rate, in step 560. For example, if the current screen refresh rate is 80 Hz, the controller may decrease the screen refresh rate to 60 Hz.

When the controller determines that the variation (C) is equal to that of the previous data (S), i.e., C=S, in step 550, it retains the screen refresh rate at the current screen refresh rate, in step 570. For example, if the current screen refresh rate is 80 Hz, the controller may retain the screen refresh rate at 80 Hz.

When the controller determines that the variation (C) exceeds that of the previous data (S), i.e., C>S, in step 550, it adjusts the screen refresh rate to be greater than the current screen refresh rate, in step 580. For example, if the current screen refresh rate is 80 Hz, the controller may increase the screen refresh rate to 120 Hz. In order to prevent increased battery power consumption and heat generation, the controller may decrease the display resolution to be less than the previous value.

As described above, the controller can adjust the screen refresh rate in such a way as to: decrease, when the data variation is smaller than that of the previous data, it to be less than the previous screen refresh rate; retain, when the data variation is equal to that of the previous data, it at the current screen refresh rate; and increase, when the data variation is greater than that of the previous data, it to be greater than the previous screen refresh rate. Therefore, the controller doesn't rapidly change the screen refresh rate according to a user's movements, but can smoothly/continuously adjust it. The electronic device can provide more natural screen to users, considering the characteristics of the users' eyes.

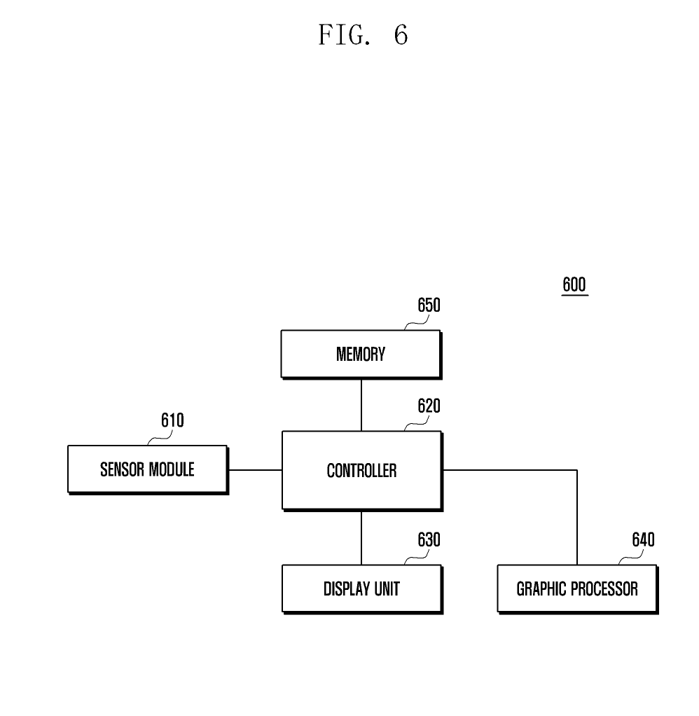

FIG. 6 is a diagram illustrating a schematic block diagram of an electronic device, according to an embodiment of the present invention.

Referring to FIG. 6, an electronic device 600 includes a sensor module 610, a controller 620, a display unit 630, a graphic processor 640 and a memory 650.

The sensor module 610 acquires data related to movements. In embodiments of the present invention, the sensor 610 may be at least one of the following: a gyro sensor, an acceleration sensor, a proximity sensor, an infrared sensor, an illuminance sensor, a GPS module, an image sensor, and a camera module.

The controller 620 determines whether a variation in acquired data exceeds a threshold, and adjusts the screen refresh rate of the display unit 630 based on the determination.

In an embodiment of the present invention, the controller 620 may calculate a variation in data acquired for a preset period of time. Specifically, the controller 620 operates a timer from a time point when it acquires the data. The sensor module 610 acquires data for the preset period of time, i.e., while the timer is operating.

The controller 620 determines whether the calculated variation exceeds the threshold.

In an embodiment of the present invention, when the controller 620 determines that the variation (C) exceeds the threshold (T), i.e., C>T, it increases the screen refresh rate greater than the threshold refresh rate. The threshold refresh rate may be set according to one of the following: the type of electronic device, the performance of the electronic device, and video data displayed on the display unit.

The graphic processor 640 processes video data to be displayed on the display unit 630. Therefore, the controller 620 controls the graphic processor 640 to adjust the screen refresh rate of the display unit 630.

In an embodiment of the present invention, when the controller determines that the variation (C) is less than or equal to the threshold (T), i.e., C<T, it decreases the screen refresh rate to be less than the threshold refresh rate or retains the screen refresh rate at the threshold refresh rate.

In an embodiment of the present invention, the controller 620 compares the variation in the acquired data with that of previous data and adjusts the screen refresh rate of the display unit based on the comparison result.

Specifically, the memory 650 stores the previous data and the current screen refresh rate. The previous data may be data acquired before the sensor module 610 is operated or data related to a current screen refresh rate at a time point that the sensor module 610 acquires data. The current screen refresh rate corresponds to the previous data.

In an embodiment of the present invention, when the controller 620 determines that the variation (C) is less than that of the previous data (S), i.e., C<S, it adjusts the screen refresh rate to be less than the current screen refresh rate.

In an embodiment of the present invention, when the controller determines that the variation (C) is equal to that of the previous data (S), i.e., C=S, it retains the screen refresh rate at the current screen refresh rate.

In an embodiment of the present invention, when the controller determines that the variation (C) exceeds that of the previous data (S), i.e., C>S, it adjusts the screen refresh rate to be greater than the current screen refresh rate.

Therefore, according to embodiments of the present invention, the electronic device 600 doesn't rapidly change the screen refresh rate according to a user's movements, but can smoothly/continuously adjust it. That is, the electronic device 600 can provide more natural screens to users, considering the characteristics of the users' eyes.

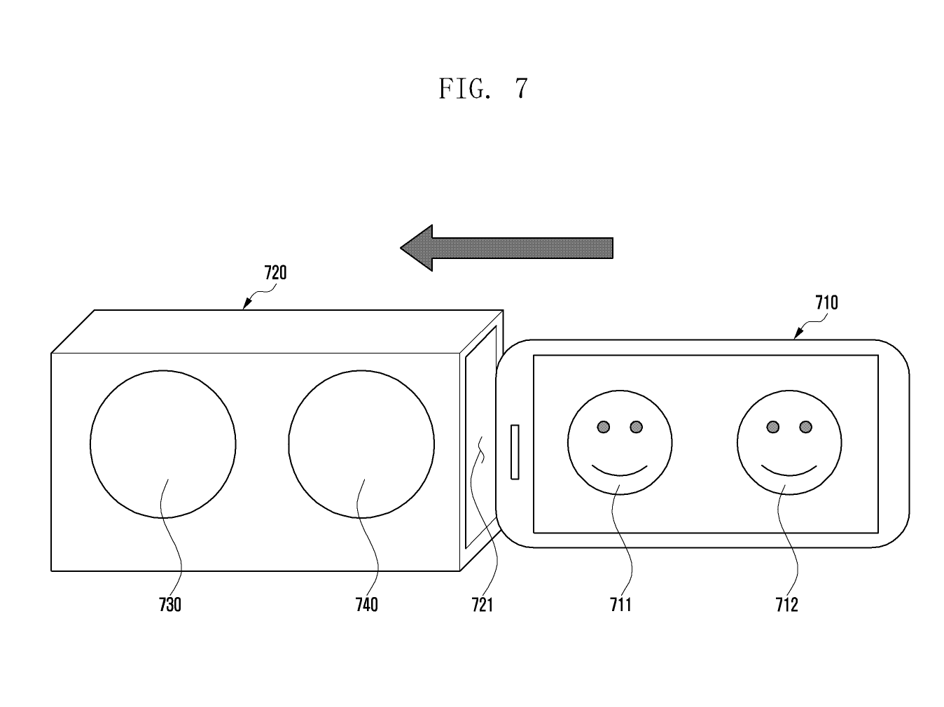

FIG. 7 is a diagram illustrating a view of a support for holding an electronic device, according to an embodiment of the present invention.

Referring to FIG. 7, an electronic device 710 displays an image 711 for the left eye and an image 712 for the right eye on the screen. A support 720 may include a lens unit. The lens unit is equipped with a left lens 730 and a right lens 740. The support 720 includes a slot 721 at one end of the body for receiving the electronic device 710. When the electronic device 710 is placed in the support 720 through the slot 721, the images on the screen of the electronic device 710 are transferred to the user's left and right eyes through the left 730 and right 740 lenses. That is, the image 711 for the left eye and the image 712 for the right eye are transferred to the user's left and right eyes through the left 730 and right 740 lenses, respectively.

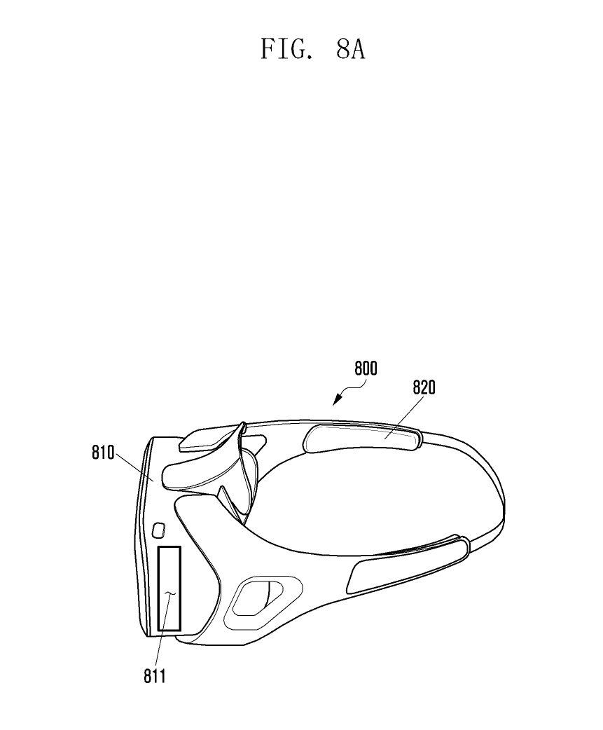

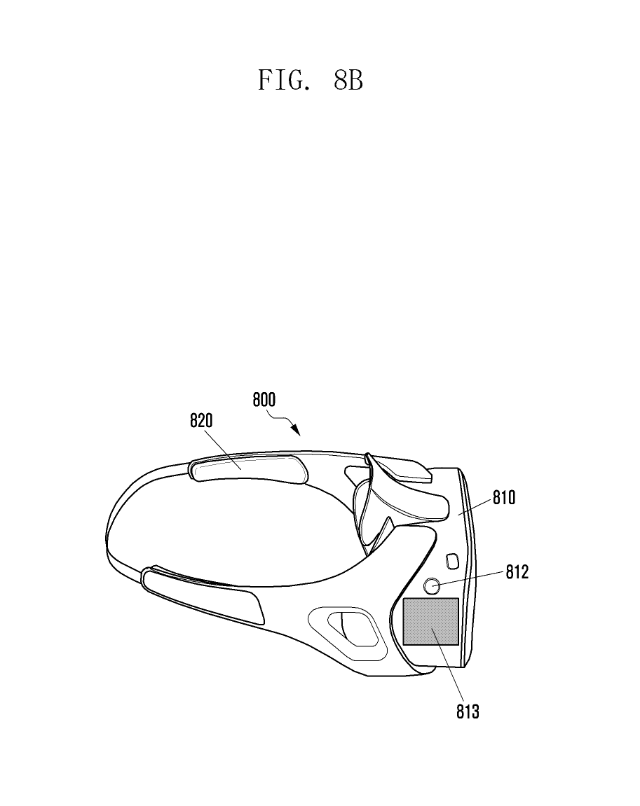

FIGS. 8A and 8B are diagrams illustrating right and left perspective views of a head-mounted device, according to an embodiment of the present invention.

Referring to FIGS. 8A and 8B, a head-mounted device 800 is a device worn on the head, like eyeglasses, and includes a support 810 and a pair of legs 820. As shown in FIG. 8A, the support 810 includes an opening 811 at one side into which an electronic device (e.g., the electronic device 710) is inserted. As shown in FIG. 8B, the support 810 includes an input unit, e.g., a button 812 and a touch pad 813, on the other side. The user can operate the electronic device inserted into the support 810 by using the input unit. The support 810 may further include a connector in the inside that is electrically and mechanically connected to the electronic device. When the user pushes the button 812 of the support 810, the electronic device may operate, for example, the camera and display a preview image on the display.

The electronic device, according to an embodiment of the present invention, includes a sensor for acquiring data related to a screen display and a controller for determining whether to adjust a screen refresh rate of the display based on the data acquired by the sensor, and adjusting the screen refresh rate according to the determination result.

In an embodiment of the present invention, the operations of acquiring data related to screen display, determining whether to adjust a screen refresh rate based on the acquired data, and adjusting the screen refresh rate of the display based on the determination, may be implemented with an executable program/software and stored in computer-readable recording media.

As described above, the system and method according to embodiments of the present invention, can dynamically adjust output of a display according to data from sensors.

The system and method, according to embodiments of the present invention, can dynamically adjust a screen refresh rate of a display according to a user's movements, thereby enhancing the use convenience.

The system and method, according to embodiments of the present invention, can continuously adjust a screen refresh rate of a display by comparing a user's movements with the previous data, thereby providing more natural screens.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A method for adjusting output of a display, the method comprising the steps of:
acquiring data related to the display output;
determining whether to adjust a screen refresh rate of the display based on the acquired data; and
adjusting or maintaining the screen refresh rate according to a result of the determination.

2. The method of claim 1, wherein determining whether to adjust the screen refresh rate comprises:
calculating a variation in data acquired for a preset period of time; and
determining whether the calculated variation exceeds a threshold.

3. The method of claim 2, wherein adjusting or maintaining the screen refresh rate comprises:
retaining the screen refresh rate at a threshold refresh rate, when the calculated variation is less than or equal to a threshold; and
increasing the screen refresh rate to be greater than the threshold refresh rate, when the calculated variation exceeds the threshold.

4. The method of claim 2, wherein adjusting or maintaining the screen refresh rate comprises:
decreasing the screen refresh rate to be less than a threshold refresh rate, when the calculated variation is less than or equal to the threshold; and
increasing the screen refresh rate to be greater than the threshold refresh rate, when the calculated variation exceeds the threshold.

5. A method for adjusting an output of a display, the method comprising the steps of:
acquiring data related to the display output;
comparing the acquired data with previous data; and
adjusting or maintaining a screen refresh rate of the display according to a result of the comparison.

6. The method of claim 5, wherein comparing the acquired data with the previous data comprises:
extracting the previous data, which is related to a current screen refresh rate at a time point when the data related to the display is acquired;
calculating a variation in the data acquired for a preset period of time; and
comparing the calculated variation with that of the previous data.

7. The method of claim 6, wherein adjusting the screen refresh rate comprises:
decreasing the screen refresh rate to be less than the current screen refresh rate, when the calculated variation is less than that of the previous data;
retaining the screen refresh rate at the current screen refresh rate, when the calculated variation is equal to that of the previous data; and
increasing the screen refresh rate to be greater than the current screen refresh rate, when the calculated variation exceeds that of the previous data.

8. The method of claim 5, wherein acquiring the data comprises:
acquiring the data, which is related to movements, by using at least one of a gyro sensor, an acceleration sensor, a humidity sensor, a proximity sensor, an infrared sensor, a illuminance sensor, an image sensor, and an earth magnetic field sensor.

9. The method of claim 5, wherein the screen refresh rate comprises a frame rate or a refresh rate.

10. An electronic device comprising:
a sensor configured to acquire data related to a display; and
a controller configured to determine whether to adjust a screen refresh rate of the display based on the acquired data, and adjust or maintain the screen refresh rate according to a result of the determination.

11. The electronic device of claim 10, wherein the sensor acquires the data, which is related to movements, by using at least one of a gyro sensor, an acceleration sensor, a humidity sensor, a proximity sensor, an infrared sensor, an illuminance sensor, an image sensor, and an earth magnetic field sensor.

12. The electronic device of claim 10, wherein the controller is further configured to calculate a variation in the data acquired for a preset period of time, and determine whether the calculated variation exceeds a threshold.

13. The electronic device of claim 12, wherein the controller is further configured to:
retain the screen refresh rate at a threshold refresh rate, when the calculated variation is less than or equal to the threshold; and
increase the screen refresh rate to be greater than the threshold refresh rate, when the calculated variation exceeds the threshold.

14. The electronic device of claim 10, wherein the controller is further configured to:
calculate a variation in the data acquired for a preset period of time;
compare the calculated variation with that of the previous data; and
adjust the screen refresh rate of the display according to a result of the comparison.

15. The electronic device of claim 14, wherein the controller is further configured to:
extract the previous data which is related to a current screen refresh rate at a time point when the data related to the display output is acquired; and
compare the calculated variation with the that of previous data.

16. The electronic device of claim 15, wherein the controller is further configured to:
decrease the screen refresh rate to be less than the current screen refresh rate, when the calculated variation is less than that of the previous data; and
increase the screen refresh rate to be greater than the current screen refresh rate, when the calculated variation exceeds that of the previous data.

17. The electronic device of claim 15, wherein the controller is further configured to retain the screen refresh rate at the current screen refresh rate, when the calculated variation is equal to that of the previous data.

18. The electronic device of claim 10, wherein the electronic device is a head-mounted device with a lens unit.

19. The electronic device of claim 18, further comprising:
a support into which the display is fitted or separated from.

20. A non-transitory computer-readable recording medium comprising a program for executing operations of:
acquiring data related to a display output;
determining whether to adjust a screen refresh rate of the display based on the acquired data; and
adjusting or maintaining the screen refresh rate based on a result of the determination.
